(19) United States
(12) Patent Application Publication
(10) Pub. No.: US 2025/0139867 A1
(43) Pub. Date: May 1, 2025

(54) CONTEXTUAL ADAPTATION OF VIRTUAL OBJECTS IN VOLUMETRIC VIDEO

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Archana Ponnada, Hyderabad (IN)

(21) Appl. No.: 18/496,987

(22) Filed: Oct. 30, 2023

(51) Int. Cl. G06T 13/40; G06F 3/01; G06T 13/20; G06T 15/08; G06T 19/00; G09B 7/02; G10L 15/18; G10L 15/22; G10L 25/57

(52) U.S. Cl. CPC G06T 13/40; G06F 3/013; G06T 13/205; G06T 15/08; G06T 19/00; G09B 7/02; G10L 15/18; G10L 15/22; G10L 25/57; G10L 2015/223

(57) ABSTRACT

An approach for adapting volumetric objects in response to user prompts or commands may be presented. The approach may consist of training a 3-D Generative Adversarial Network to manipulate volumetric objects based on generated responses to prompts and user manipulations within a virtual reality environment. The approach may include identifying a volumetric object a user prompt is directed to and generating an appropriate auditory response to the prompt in a natural language format. The approach may also include adapting the identified object based on the response or mapping the correct manipulation to the volumetric object to provide movement synced to the auditory response.

### BACKGROUND

The present invention relates to artificial intelligence and machine learning, and more specifically, to contextual adaptation of virtual objects in recorded volumetric videos.

Volumetric video is a three-dimensional (“3D”) media format which allows users to view a recorded subject from any angle. Volumetric video is captured using multiple cameras simultaneously filming at different angles. Advanced data processing renders the captured data into a 3D virtual space. Volumetric video, while similar to hologram technology, differs from holograms in that holograms are projected from a two-dimensional diffraction screen to obtain a 3D image within a 3D space, while volumetric video is contained within its own 3D space.

Cameras used to capture record the subject are equipped with light detection and ranging and/or infrared sensors. The captured data from the cameras is rendered into a point cloud. A point cloud is a set of data points in a 3D coordinate system, where each point represents a spatial measurement on an object's surface. The point cloud can also include RGB values associated with each data point in the 3D coordinate system. Thus, a point cloud can represent the entire external surface of an object. Volumetric video is different from a 360-degree video, in that it provides depth to the recording. In 360-degree video, users can only view the video from a single, constant depth. Using a virtual reality system or an augmented reality system in conjunction with volumetric video, users can control how explore the volumetric video in 3D due to the associated depth.

### SUMMARY

According to an embodiment of the present invention, a computer implemented method for contextual adaptation of virtual objects in a volumetric interface may be disclosed. The computer-implemented method comprising A computer-implemented method for contextual adaptation of virtual objects in a volumetric interface, the computer-implemented method comprising identifying, by a processor, a corpus of volumetric video content containing a first volumetric object, wherein the corpus of volumetric video is associated with a human avatar which is comprised of a plurality of human spoken contents and a plurality of human body language data. Extracting, by the processor, a plurality of video frames from the corpus of volumetric video content, wherein the volumetric video content contains a plurality of viewing angles of the first volumetric object, wherein extracting is based on applying a convolutional neural network to the identified corpus of volumetric video content. Training, by the processor, a generative adversarial network to adapt a volumetric object, based at least in part on the plurality of extracted video frames from the corpus of volumetric video content. Adapting, by the processor, the first volumetric object, based on the trained generative adversarial network.

According to another embodiment of the present invention, a computer system for contextual adaptation of virtual objects in a volumetric interface may be disclosed. The computer system may comprise a computer processor, a computer memory, a computer readable storage device, and computer program instructions stored on the computer readable storage device, executable by the processor, to perform one or more operations. The computer system may include program instructions to identify a corpus of volumetric video content containing a first volumetric object, wherein the corpus of volumetric video is associated with a human avatar which is comprised of a plurality of human spoken contents and a plurality of human body language data. The computer system may include program instructions to extract a plurality of video frames from the corpus of volumetric video content, wherein the volumetric video content contains a plurality of viewing angles of the first volumetric object and wherein extracting is based on applying a convolutional neural network to the identified corpus of volumetric video content. The computer system may include program instructions to train a generative adversarial network to adapt a volumetric object, based at least in part on the plurality of extracted video frames from the corpus of volumetric video content. The computer system may include program instructions to adapt the first volumetric object, based on the trained generative adversarial network.

According to yet another embodiment of the present invention, a computer program product for contextual adaptation of virtual objects in a volumetric interface may be disclosed. The computer program product may comprise a computer readable storage device having program instructions embodied therewith, the program instructions executable by a processor to cause the processors to perform a function. The computer program product may include program instructions to identify a corpus of volumetric video content containing a first volumetric object, wherein the corpus of volumetric video is associated with a human avatar which is comprised of a plurality of human spoken contents and a plurality of human body language data. The computer program product may include program instructions to extract a plurality of video frames from the corpus of volumetric video content, wherein the volumetric video content contains a plurality of viewing angles of the first volumetric object and wherein extracting is based on applying a convolutional neural network to the identified corpus of volumetric video content. The computer program product may include program instructions to train a generative adversarial network to adapt a volumetric object, based at least in part on the plurality of extracted video frames from the corpus of volumetric video content. The computer program product may include program instructions to adapt the first volumetric object, based on the trained generative adversarial network.

### BRIEF DESCRIPTION OF THE DRAWINGS

FIG. 1 is a block diagram depicting an exemplary computing environment, in accordance with an embodiment of the invention.

FIG. 2A is a block diagram depicting an exemplary system for adaptation of volumetric objects, in accordance with an embodiment of the invention.

FIG. 2B is a block diagram depicting volumetric object adaptation engine 200, in accordance with an embodiment of the invention.

FIG. 3 is a block diagram depicting generative adversarial network 300, in accordance with an embodiment of the invention.

FIG. 4 is a flowchart, depicting the steps of adapting a volumetric object in a volumetric video in accordance with an embodiment of the invention.

FIG. 5 is a flowchart, depicting the steps of generating a response by adapting a volumetric object in response to a prompt.

### DETAILED DESCRIPTION

Current volumetric video or volumetric capture technologies allow for a user to engage a previously recorded or live volumetric video in a three-dimensional space. However, in a previously captured volumetric video, a user is not able to actively engage with the objects within that video (e.g., elicit a response from the objects with the video visually). This also includes interaction in the form of auditory queries and prompts. Rather, a user may only explore and observe the objects within the volumetric video. For example, a user cannot ask question to the volumetric object (e.g., a human avatar) on the topic that is being discussed in the video and receive an appropriate auditory response or visual responses corresponding to the posed question (e.g., facial features and lip movement associated with speaking). It would be advantageous to develop capabilities where a user may interact with an object of within volumetric video and elicit a visual and/or auditory response. Volumetric as used herein shall refer to three dimensional.

Embodiments of the present invention recognize the advantages of adaptation of volumetric objects in a previously captured volumetric video in response to a user interaction. In an embodiment of the present invention, in response to a user interaction, a volumetric object may be adapted visually. For example, a user interacting with a previously captured classroom setting via virtual reality or augmented reality system may pose an auditory or text based prompt to the instructor within the classroom setting. The instructor is a volumetric object within the volumetric video also known as a “human avatar”. An appropriate auditory response can be generated based on a knowledge corpus of the human avatar and a generative network, further, a visual response can be generated, resulting in facial, lip and body movements corresponding to the human avatars auditory response.

Embodiments of the present invention can identify all the volumetric objects present in a volumetric video (e.g., human avatars, furniture, animals, etc.). For example, in a volumetric recording containing a volumetric object, embodiments may utilize a convolutional neural network configured to identify a volumetric object. An embodiment can extract video frames from volumetric videos and utilize a Convolutional Neural Networks (CNN) on the extracted images to identify different images or objects.

Embodiments of the present invention may receive a prompt associated with a volumetric video. Embodiments may further, generate a response to the prompt, based on a natural language processing system. The response may be a vocal human or auditory response, and the vocal or auditory human response can have an associated emotional response. Embodiments of the present invention may also manipulate a volumetric object into a series of positions corresponding to the generated response. The series of positions may be one or more facial and body movements which correspond to the response generated for the prompt.

Embodiments of the present invention may further identify a plurality of volumetric objects in the volumetric video environment. The plurality of volumetric objects may be comprised of the human avatar, and the volumetric video can be a virtual reality environment. Additionally, embodiments, may select a first volumetric object from the plurality of volumetric objects. The first volumetric object can be the human avatar. A human avatar is a representation or volumetric capture of a previously recorded human in the virtual reality environment.

Embodiments of the present invention may monitor a user's body language in response to adapting a first volumetric object, based on a virtual reality system. Additionally, embodiments may determine an output corresponding to the monitored user's body language, based on a generative adversarial network and a natural language processing unit. Further, embodiments may adapt the first volumetric object based on the determined corresponding output to the monitored user's body language.

An embodiment, may further, continuously monitor, the spatial orientation of the virtual reality system and update the adaptation of the first volumetric object via the trained generative adversarial network, continuously, in real-time, based on the monitoring of the virtual reality system and a received query.

An embodiment of the invention can adapt a volumetric video object with a Generative Adversarial Network (GAN). The GAN can be configured to operate within a three-dimensional generate environment to adapt volumetric video objects within the volumetric video environment, this is known as a 3-D GAN. The 3-D GAN is trained with a knowledge corpus, the knowledge corpus is prior or historical knowledge, from the volumetric video. Embodiments may also utilize additional images, body language and spoken content to train the 3-D GAN.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure, or characteristic in connection with an embodiment, one skilled in the art has the knowledge to affect such feature, structure or characteristic in connection with other embodiments whether or not explicitly described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

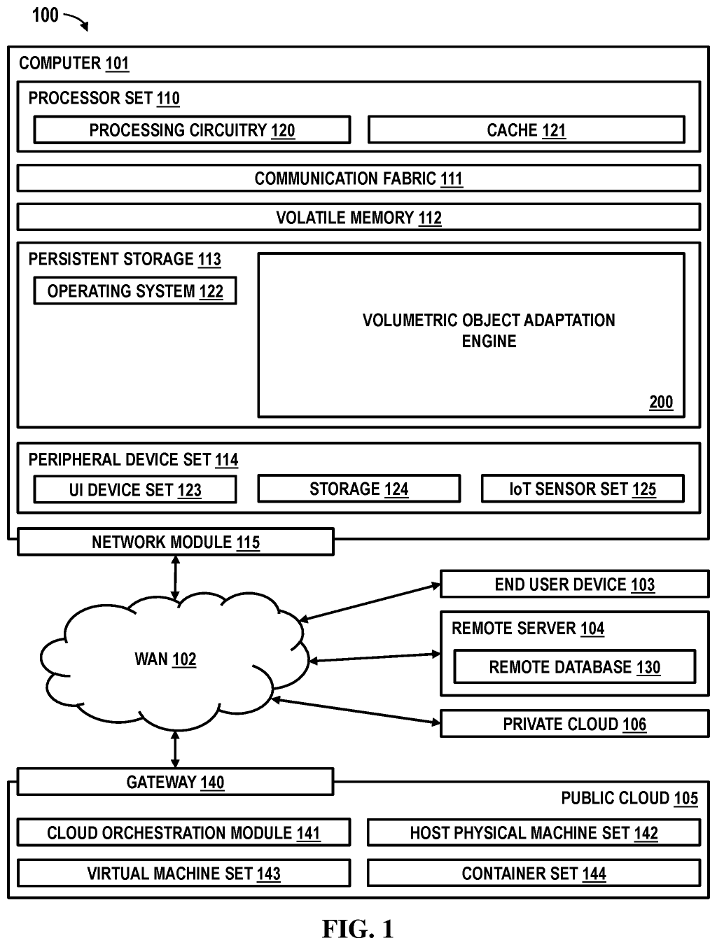

Now with reference to FIG. 1. FIG. 1 depicts Computing environment 100. Computing environment 100 contains an example of an environment for the execution of at least some of the computer code involved in performing the inventive methods, such as Volumetric Object Adaptation Engine 200. In addition to volumetric object adaptation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and volumetric object adaptation engine 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in volumetric object adaptation engine 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in volumetric adaptation engine 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

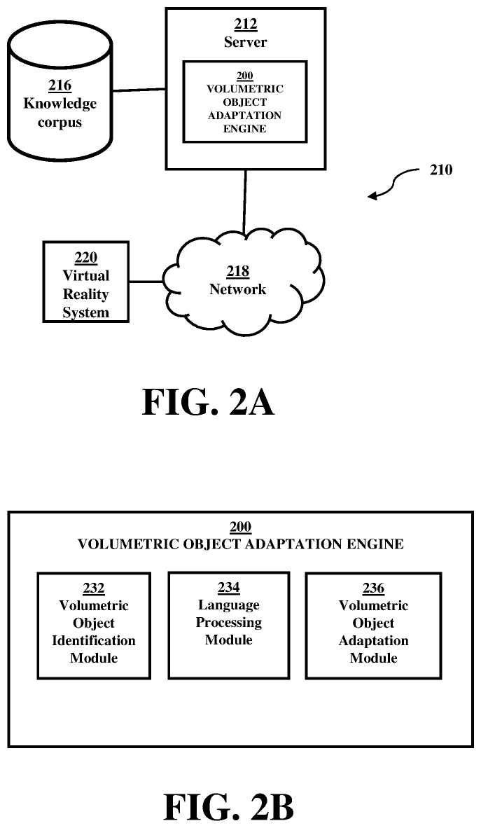

FIG. 2A is a block diagram of computer system 210, in accordance with an embodiment of the invention. As depicted in FIG. 2, computer system 210 comprises: server 212. Operational on server 212 is volumetric object adaptation engine 200 (described in further detail in FIG. 2B). Server 212 is connected to network 218 and knowledge corpus 216. Connected to network 218 is virtual reality system 220.

Knowledge corpus 216 is a databased with historical data comprised of volumetric video or volumetric captures containing volumetric objects. The historical data stored on knowledge corpus 216 can be used to train a 3-D GAN (described further below) to adapt volumetric objects within a volumetric capture space. The volumetric objects contained within the historical data can be any object, item, or individual captured by a volumetric recording. For example, knowledge corpus 216 may contain many hours of human interactions with other people, or human interactions with objects such as machinery, vehicles, furniture, appliances, animals, and plants.

Virtual reality system 220, is a computing device that allows a user to interact with a volumetric capture environment. For example, virtual reality system 220 can have a headset worn by a user and effectively imports the user to a completely virtual environment (i.e., virtual reality (“VR”)) visually and auditorily. In another example, virtual reality system 220 can be a device which allows a user to experience augmented reality (AR) in a natural environment. Non-limiting examples of VR/AR devices include Meta Quest 2®, Meta Quest Pro®, Sony PlayStation VR2®, HTC Vive Pro 2®, Google Glass®, and Apple Vision Pro®. Virtual reality system 220, can also have a microphone or user interface devices which allow for a natural language input. The natural language input can allow for a user prompt for generating a natural language response of a volumetric object within a volumetric capture. Furthermore, VR device system 220 can have sensors (e.g., accelerometer, position sensors, temperature sensors, moisture sensors, etc.) which allow for it to detect the movement of the user to identify patterns and motions related to human body language and gestures. It should be noted, virtual reality system 220 while shown directly connected to network 218, can also be connected directly to server 212 or any other computing device capable of communication with virtual reality system 220.

FIG. 2B depicts a block diagram of volumetric object adaptation engine 200. Shown operational on volumetric object adaptation engine 200 is volumetric object identification module 232, natural language processing module 234, and object adaptation module 236. In an embodiment, volumetric object adaptation engine 200 can identify a volumetric object within a volumetric capture. Further, volumetric object adaptation engine 200 can receive a natural language prompt from a user as input and generate an appropriate natural language response to the prompt. Further yet, volumetric object adaptation engine 200 can adapt a volumetric object to visually correspond to the generated natural language response. For example, if a user poses a question to a human avatar in a volumetric capture, volumetric object adaptation engine 200 can generate an appropriate response to the question and adapt the human avatar with body language and facial features corresponding to the generated response.

In an embodiment, a user may interact or manipulate a volumetric object physically (e.g., picking up an item, opening a door, disassembling an item), through VR system 220. In this immediate example, if manipulating an object, volumetric object adaptation engine 200 can adapt the volumetric object which is being manipulating to correspond to the received physical manipulation (i.e., turning a door handle and pushing a door open).

Volumetric object identification module 232 is a computing module which can identify volumetric objects in a volumetric capture. In an embodiment, volumetric object identification module 232 can be configured to extract frames (e.g., a point cloud) of volumetric captures identify volumetric objects within the extracted frames. In an embodiment, extracted frames can be input into a convolutional neural network configured to identify objects within the extracted frame. For example, volumetric object identification module 232 may receive an input volumetric capture. Volumetric object identification module 232 may then separate individual frames captured by separate volumetric cameras. Volumetric object identification module 232 can utilize a CNN to identify objects within the frames. This can occur iteratively over numerous frames, where the object can be identified over numerous angles at corresponding time frames.

Language processing module 234 is a computer module that can receive auditory, or text based natural language as input and extract meaning from the input. Further, based on the extracted input, Language processing module 234 can generate a natural language response to the input and convert the response into an auditory response. In an embodiment, language processing module 234 can be a chatbot with a generative prediction tensor model for generating natural language responses to a user prompt. In an embodiment, language processing module 234 can have an automatic speech recognition capacity, which can receive an auditory prompt and transcribe the auditory prompt into text to for input into a Natural Language Processing model operational on language processing module 234 to extract the meaning of the prompt.

In an embodiment, if a user prompts a volumetric object such as a human avatar using the microphone on a virtual reality system such as VR system 220, language processing module 234 can receive the auditory prompt. Language processing module 234 can utilize an automatic speech recognition model to transcribe the auditory prompt. Further, a natural language processing unit (e.g., WatsonX® by IBM Inc., Bard® by Alphabet, Inc., by chat-GPT by OpenAI® or similar transformer based large language model) can extract meaning from the transcription and generate an appropriate response to the prompt. Language processing module 234 can then send the response to volumetric object adaptation module 236.

Volumetric object adaptation module 236 is a computer module that can receive and input, such as a response from language processing module 234 and/or a volumetric object identification input from volumetric object identification module 232. Volumetric object adaptation module 236 can utilize a 3-D generative adversarial network (GANs are described in further detail below) to adapt the volumetric object in response to a user interaction or prompt. A 3-D GAN is a GAN trained to generate frames with a volumetric object within a volumetric capture space, however, the GAN outputs a generated frame in a volumetric format (i.e., point clouds and RGB factors associated with the point clouds) For example, if a response to a user prompt is received from language processing module 234 volumetric object adaptation module 236 can receive or obtain as input the volumetric object corresponding to the prompt, identified by volumetric object identification module 232.

Volumetric object adaptation module 236 can adapt or reconfigure the volumetric object based on a 3-D GAN trained with a knowledge corpus of associated volumetric objects. For example, the adaptation to the volumetric object can be to the facial features of a human avatar, resulting a a seamless lip synching. Further, the human avatar can have associated body language resulting in a corresponding adaptation (e.g., the avatar crossing its arms, sitting in a seat, or walking in a direction. In another embodiment, if the prompt is a command for the human avatar to perform and action, no auditory response will be generated, but language processing model will input the command into volumetric object adaptation module 236 as an instruction for how to manipulate the volumetric object.

In an embodiment, volumetric object adaptation module 236 can receive instructions on adapting a volumetric object from the sensors of VR system 220. For example, based on a location in a volumetric VR environment, commands from the VR system 220 resulting in interaction with a volumetric object can cause a change in the orientation of a volumetric object such as a bicycle, rugby ball, or door. Based on the commands of VR system 220 volumetric object adaptation module 236 can utilize a 3-D GAN to render and change the orientation or spatial location of the object within the VR or augmented reality environment.

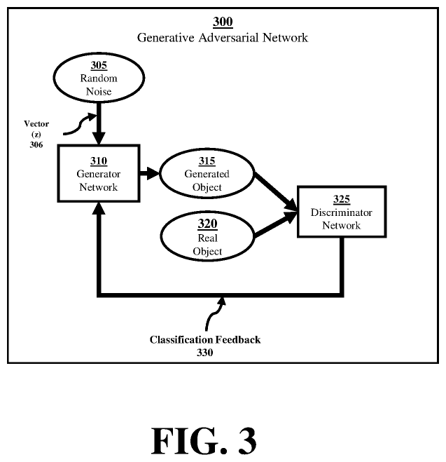

With reference now to FIG. 3. FIG. 3 is an example block diagram of generative adversarial network 300. A generative adversarial network is a machine learning model with two deep learning networks which compete against each other in a zero sum game to train and improve each other via a double feedback loop. The goal of a generative adversarial network is to train the generator network to produce images or data which the discriminator network cannot distinguish as artificial. In other words, the intended outcome is to trick a trained discriminator network into classifying artificial images as real ones. Generative adversarial network is comprised of generator network 310 and discriminator network 325. Generative adversarial network 300 is comprised of generator network 310 and discriminator network 325. In an embodiment, generator network 310 can be a convolutional network with multiple layers and levels of convolutions. In an embodiment, discriminator network 325 can be a deconvolutional network and a coupled classification network.

In an embodiment, generator network 310 can obtain or receive vector (z) 306 and transform it into generated image 315. Vector (z) 306 may also be sampled from random noise 305 (e.g., gaussian noise or noise conditioned with structured input). In an embodiment, vector (z) 306 can be transformed by generator network 310 based on a probabilistic model (e.g., where generator network 310 mimics a data distribution (i.e., a p-data) of real images). Further as shown in FIG. 1, batches of generated images 315 and real images 320 can be sent to discriminator network 325 for classification. In an embodiment, discriminator network 325 can classify generated images 315 and real images 320 as real or fake. Classification feedback 330 from discriminator network 325 can be sent to generator network 310 for further tuning and training of generator network 310.

With an appropriate optimization technique, the neural networks of the generator network 310 and discriminator network 325 may be trained to reach an optimal point. The optimal generator network 310 will produce realistic images and the optimal discriminator network 325 will estimate the likelihood of a given image being real.

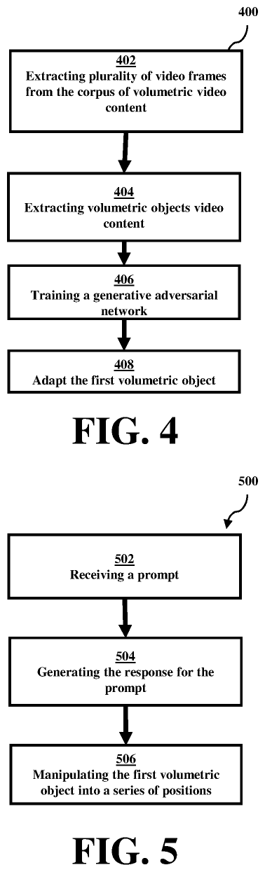

With reference now to FIG. 4. FIG. 4 is flowchart depicting the steps of the invention and is generally designated as 400. At step 402 volumetric identification module extracts volumetric objects from volumetric video content stored on knowledge corpus 216. At step 404, Volumetric object identification module 232 identifies volumetric objects from the extracted video frames. At step 406, the extracted volumetric objects and corresponding natural language extracted by language processing module 234 are input into volumetric object adaptation module 236 to train a 3-D generative adversarial network operational on volumetric object adaptation module 236. At step 408, volumetric object adaptation module 236 can receive and adapt an input volumetric object, based on the trained 3-D GAN.

With reference now to FIG. 5. FIG. 5 is a flowchart, generally designated as 500, depicting the process of manipulating a volumetric object and producing a response to a prompt from a user. At step 502, volumetric object adaptation engine 200 receives a prompt from a user. For example, a user can use VR system 220 to input a command or prompt, in natural language or text form, directed to a volumetric object. At step 504, volumetric object adaptation engine 200 can generate a response to the prompt or command. For example, volumetric object identification module 232 can identify the volumetric object which the prompt is directed to based off of the orientation of the user in a VR or AR environment. Language processing module 234 can extract meaning from the prompt and generate a response for the prompt, appropriate to the identified volumetric object. At Step 506, volumetric adaptation module 236 can manipulate the identified volumetric object based on the generated response.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for contextual adaptation of virtual objects in a volumetric interface, the computer-implemented method comprising:
identifying, by a processor, a corpus of volumetric video content containing a first volumetric object, wherein the corpus of volumetric video is associated with a human avatar which is comprised of a plurality of human spoken contents and a plurality of human body language data;
extracting, by the processor, a plurality of video frames from the corpus of volumetric video content, wherein the volumetric video content contains a plurality of viewing angles of the first volumetric object, wherein extracting is based on applying a convolutional neural network to the identified corpus of volumetric video content;
training, by the processor, a generative adversarial network to adapt a volumetric object, based at least in part on the plurality of extracted video frames from the corpus of volumetric video content; and
adapting, by the processor, the first volumetric object, based on the trained generative adversarial network.

2. The method of claim 1, wherein adapting comprises:
receiving, by the processor, a prompt associated with the volumetric video;
generating, by the processor, a response to the prompt, based on a natural language processing system, wherein the response is a vocal human response, and wherein the vocal human response has an associated emotional response; and
manipulating, by the processor, the first volumetric object into a series of positions corresponding to the generated response, wherein the series of positions can be one or more facial and body movements corresponding to the generated prompt response.

3. The computer-implemented method of claim 1 further comprising:
identifying, by the processor, a plurality of volumetric objects in the volumetric video, environment, wherein the plurality of volumetric objects is comprised of the human avatar, and wherein the volumetric video is a virtual reality environment; and
selecting, by the processor, a first volumetric object from the plurality of volumetric objects, wherein the first volumetric object is the human avatar, wherein a human avatar is a representation of a previously recorded human in the virtual reality environment.

4. The computer-implemented method of claim 1 further comprising:
identifying, by the processor, the position of the eye of the user;
monitoring, by the processor, the spatial orientation of a virtual reality system, wherein the virtual reality device is a virtual reality headset;
activating, by the processor, the first volumetric object, based at least in part on the identified eye position and a prompt; and
determining, by the processor, one or more viewing angles of the first volumetric object, based at least in part on monitoring the spatial orientation and the eye position of a virtual reality system.

5. The computer-implemented method of claim 1 further comprising:
monitoring, by the processor, a user's body language in response to adapting the first volumetric object, based on a virtual reality system; and
determining, by the processor, a corresponding output to the monitored user's body language, based at least in part on the generative adversarial network and the natural language processing unit; and
adapting, by the processor, the first volumetric object based on the determined corresponding output to the monitored user's body language.

6. The computer-implemented method of claim 1, wherein the corpus of volumetric video content is associated with a classroom setting and wherein the first volumetric object is an instructor within the classroom setting.

7. The computer-implemented method of claim 4, further comprising;
continuously monitoring, the spatial orientation of the virtual reality system; and
updating, by the processor, the adaptation of the first volumetric object via the trained generative adversarial network, continuously, in real-time, based at least in part on the monitoring of the virtual reality system and a received query.

8. A computer system for contextual adaptation of virtual objects in a volumetric interface, the system comprising:
a computer processor;
a computer memory;
a computer readable storage device; and
computer program instructions stored on the computer readable storage device, executable by the processor, to perform one or more operations, the one or more operations comprising:
identify a corpus of volumetric video content containing a first volumetric object, wherein the corpus of volumetric video is associated with a human avatar which is comprised of a plurality of human spoken contents and a plurality of human body language data;
extract a plurality of video frames from the corpus of volumetric video content, wherein the volumetric video content contains a plurality of viewing angles of the first volumetric object, wherein extracting is based on applying a convolutional neural network to the identified corpus of volumetric video content;
train a generative adversarial network to adapt a volumetric object, based at least in part on the plurality of extracted video frames from the corpus of volumetric video content; and
adapt the first volumetric object, based on the trained generative adversarial network.

9. The computer system of claim 8, wherein adapting further comprises program instructions to:
receive a prompt associated with the volumetric video;
generate a response to the prompt, based on a natural language processing system, wherein the response is a vocal human response, and wherein the vocal human response has an associated emotional response; and
manipulate the first volumetric object into a series of positions corresponding to the generated response, wherein the series of positions can be one or more facial and body movements corresponding to the generated prompt response.

10. The computer system of claim 8, further comprising program instructions to:
identify a plurality of volumetric objects in the volumetric video, environment, wherein the plurality of volumetric objects is comprised of the human avatar, and wherein the volumetric video is a virtual reality environment; and
select a first volumetric object from the plurality of volumetric objects, wherein the first volumetric object is the human avatar, wherein a human avatar is a representation of a previously recorded human in the virtual reality environment.

11. The computer system of claim 8, further comprising program instructions to:
identify the position of the eye of the user;
monitor the spatial orientation of a virtual reality system, wherein the virtual reality device is a virtual reality headset;
activate the first volumetric object, based at least in part on the identified eye position and a prompt; and
determine one or more viewing angles of the first volumetric object, based at least in part on monitoring the spatial orientation and the eye position of a virtual reality system.

12. The computer system of claim 8, further comprising program instructions to:
monitor a user's body language in response to adapting the first volumetric object, based on a virtual reality system; and
determine a corresponding output to the monitored user's body language, based at least in part on the generative adversarial network and the natural language processing unit; and
adapt the first volumetric object based on the determined corresponding output to the monitored user's body language.

13. The computer system of claim 8, wherein the corpus of volumetric video content is associated with a classroom setting and wherein the first volumetric object is an instructor within the classroom setting.

14. The computer system of claim 11, further comprising program instructions to:
continuously monitor the spatial orientation of the virtual reality system; and
update the adaptation of the first volumetric object via the trained generative adversarial network, continuously, in real-time, based at least in part on the monitoring of the virtual reality system and a received query.

15. A computer program product for contextual adaptation of virtual objects in a volumetric interface, the computer program product comprising:
a computer readable storage device having program instructions embodied therewith, the program instructions executable by a processor to cause the processors to perform a function, the function comprising:
identify a corpus of volumetric video content containing a first volumetric object,
wherein the corpus of volumetric video is associated with a human avatar which is comprised of a plurality of human spoken contents and a plurality of human body language data;
extract a plurality of video frames from the corpus of volumetric video content, wherein the volumetric video content contains a plurality of viewing angles of the first volumetric object, wherein extracting is based on applying a convolutional neural network to the identified corpus of volumetric video content;
train a generative adversarial network to adapt a volumetric object, based at least in part on the plurality of extracted video frames from the corpus of volumetric video content; and
adapt the first volumetric object, based on the trained generative adversarial network.

16. The computer program product of claim 15, wherein adapting further comprises program instructions to:
receive a prompt associated with the volumetric video;
generate a response to the prompt, based on a natural language processing system, wherein the response is a vocal human response, and wherein the vocal human response has an associated emotional response; and
manipulate the first volumetric object into a series of positions corresponding to the generated response, wherein the series of positions can be one or more facial and body movements corresponding to the generated prompt response.

17. The computer program product of claim 15, further comprising program instructions to:
identify a plurality of volumetric objects in the volumetric video, environment, wherein the plurality of volumetric objects is comprised of the human avatar, and wherein the volumetric video is a virtual reality environment; and
select a first volumetric object from the plurality of volumetric objects, wherein the first volumetric object is the human avatar, wherein a human avatar is a representation of a previously recorded human in the virtual reality environment.

18. The computer program product of claim 15, further comprising program instructions to:
identify the position of the eye of the user;
monitor the spatial orientation of a virtual reality system, wherein the virtual reality device is a virtual reality headset;
activate the first volumetric object, based at least in part on the identified eye position and a prompt; and
determine one or more viewing angles of the first volumetric object, based at least in part on monitoring the spatial orientation and the eye position of a virtual reality system.

19. The computer program product of claim 15, further comprising program instructions to:
monitor a user's body language in response to adapting the first volumetric object, based on a virtual reality system; and
determine a corresponding output to the monitored user's body language, based at least in part on the generative adversarial network and the natural language processing unit; and
adapt the first volumetric object based on the determined corresponding output to the monitored user's body language.

20. The computer program product of claim 15, wherein the corpus of volumetric video content is associated with a classroom setting and wherein the first volumetric object is an instructor within the classroom setting.
